(19) United States
(12) Patent Application Publication
(10) Pub. No.: US 2012/0195464 A1
(43) Pub. Date: Aug. 2, 2012

(54) AUGMENTED REALITY SYSTEM AND METHOD FOR REMOTELY SHARING AUGMENTED REALITY SERVICE

(75) Inventor: Kye Hyuk AHN, Bucheon-si (KR)

(73) Assignee: PANTECH CO., LTD., Seoul (KR)

(21) Appl. No.: 13/312,904

(22) Filed: Dec. 6, 2011

(30) Foreign Application Priority Data
Jan. 27, 2011 (KR) 10-2011-0008074

(51) Int. Cl. G06K 9/00; G06F 15/16

(52) U.S. Cl. 382/103; 709/227

(57) ABSTRACT

An augmented reality (AR) system and method for remotely sharing an AR service is provided. The AR system includes a plurality of client devices and a host device. The AR system allows information related to a marker and information related an AR object to be shared between client devices participating in an AR session, which may be separated by a reference distance, through a host device. Accordingly, an AR service may be shared between the client devices.

### CROSS-REFERENCE TO RELATED APPLICATION

This application claims priority from and the benefit under 35 U.S.C. §119(a) of Korean Patent Application No. 10-2011-0008074, filed on Jan. 27, 2011, which is incorporated herein by reference for all purposes as if fully set forth herein.

### BACKGROUND

1. Field

This disclosure relates to an augmented reality (AR) system and method, and more particularly to an AR system and method for remotely sharing an AR service.

2. Discussion of the Background

An augmented reality (AR) technology is one form of a virtual reality is technology that combines an image of a real world environment, which a user may view through eyes of the user, with virtual world information that may not be readily available in the real world environment to display a combined image. The AR technology may be based on a concept for supplementing the image of the real world with information available in a virtual world. The AR technology may use a virtual environment created by a computer graphic technique, which may be based on the real world.

The computer graphic technique may provide additional information that may not be readily available in the real world to the image of the real world environment. That is, distinguishing between the real world and the virtual world may be difficult at times due to the computer graphic technique overlapping a three-dimensional virtual image having virtual information or an AR object on the image of a real world. Accordingly, the AR technology may immerse the user in the virtual environment so the user may view both the real world environment information and the integrated virtual information. The AR technology may be implemented so that a computer may recognize a predetermined marker and display a three-dimensional graphic model mapped to the marker on a display monitor. Here, the marker may exist on a two-dimensional flat plane, and the marker alone may provide size, direction and location information of a three-dimensional graphic model mapped to the marker to an output device including a monitor. The marker and the three-dimensional graphic model may vary depending on selection of the user.

Conventionally, the marker-based AR technology enables users to apply a three-dimensional graphic model of each user to a marker. However, the marker-based AR technology does not provide sharing of an AR service between users separated by a distance.

### SUMMARY

Exemplary embodiments of the present invention provide an augmented reality (AR) system and method for remotely sharing an AR service.

Additional features of the invention will be set forth in the description which follows, and in part will be apparent from the description, or may be learned by practice of the invention.

Exemplary embodiments of the present invention provide a first client device of an AR system including a communication unit to transmit and receive data to and from a host device; a sharing unit to share information related to a marker and information related to an AR object with a second client device through the host device; a detection unit to detect the marker in an image; an engine unit to generate an AR object corresponding to the marker, and to display the generated AR object; and an AR executing unit to provide an AR service to provide information related to the AR object.

Exemplary embodiments of the present invention provide a host device of an AR system including a communication unit to transmit and receive data to and from client devices, and a sharing unit to enable sharing of information related to a marker and information related to an AR object between client devices participating in an AR session through the communication unit.

Exemplary embodiments of the present invention provide a method for remotely sharing an AR service, in a first client device, including obtaining an image of a real world environment; detecting a marker in the image; detecting location of the marker using a feature of the marker; generating an AR object corresponding to the marker based on the detected location of the marker; displaying the generated AR object; sharing information related to a is marker and information related to an AR object with a second client device in an AR session through a host device; and executing an AR service to provide additional or changed information related to the AR object, and sharing the additional or changed information related to the AR object with the second client device.

Exemplary embodiments of the present invention provide a method for remotely sharing an AR service in a host device, including receiving a session generation request message requesting generation of an AR session from a first client device; generating the AR session with the first client device; receiving a session participation request message requesting participation in the AR session from a second client device; determining whether participation of the second client device is permitted; transmitting information about whether participation of the second client device is permitted to the second client device; and enabling sharing of the information related to the marker and information related to an AR object between the client devices participating in the AR session.

It is to be understood that both foregoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an augmented reality (AR) system according to an exemplary embodiment of the invention.

FIG. 2 is a block diagram illustrating a structure of a host device of the AR system according to an exemplary embodiment of the invention.

FIG. 3 is a block diagram illustrating a client device of the AR system according to an exemplary embodiment of the invention.

FIG. 4 is a flowchart illustrating a method for generating an AR session in the client device according to an exemplary embodiment of the invention.

FIG. 5 is a flowchart illustrating a method for participating in an AR session in the client device according to an exemplary embodiment of the invention.

FIG. 6 is a flowchart illustrating a method for remotely executing an AR service in the client device according to an exemplary embodiment of the invention.

FIG. 7 is a flowchart illustrating a method for remotely providing an AR service in the host device according to an exemplary embodiment of the invention.

### DETAILED DESCRIPTION OF THE ILLUSTRATED EMBODIMENTS

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity, illustration, and convenience.

Exemplary embodiments of the present invention may provide an augmented reality (AR) system and method for sharing information related to a marker that may be identified in an image of a real world and information related to a corresponding AR object between a plurality of client devices that may be separated by a distance through a host device. Further, exemplary embodiments of the present invention may also provide an AR system to share an AR service between the client devices through the host device.

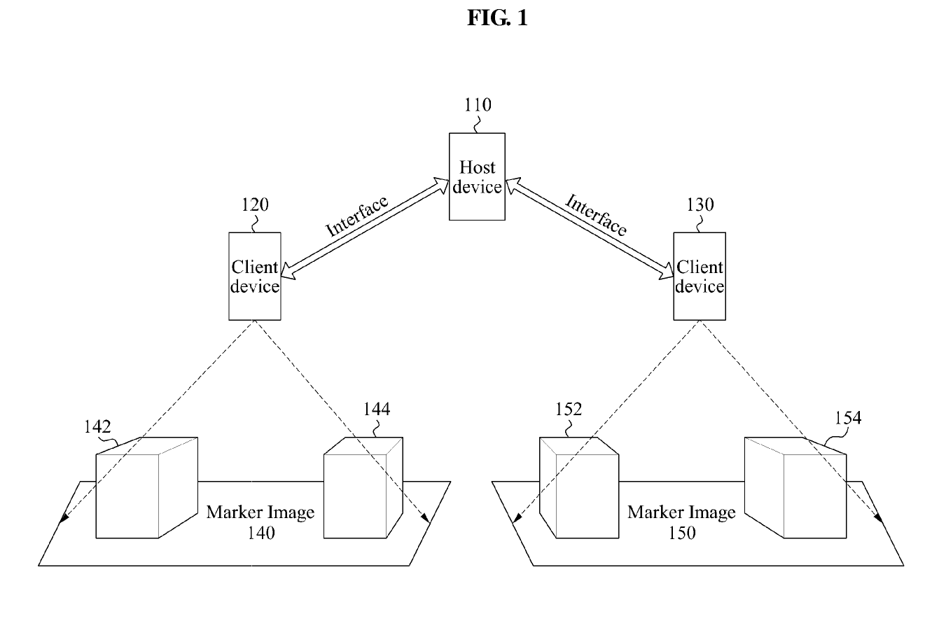

FIG. 1 is a diagram illustrating an AR system according to an exemplary embodiment of the invention.

As shown in FIG. 1, the AR system includes a host device 110, multiple client devices including a client device 120 and a client device 130, and multiple marker images including a marker image 140 and a marker image 150. The host device 110 may enable the client device 120 and the client device 130, which may be separated at a distance, to share an AR service including information related to the marker image 140 and the marker image 150.

According to aspects of the invention, a client device may refer to a terminal that may be able to communicate with other devices using a communication network. The client device may include a mobile terminal, a cellular phone, a smart phone, a laptop, a tablet computer, a personal digital assistant (PDA), and the like. A marker image may refer to an image of a real world environment, which may include one or more markers as well as associated AR objects. For example, the marker may refer to an object that may exist in a real world environment, such as a Starbucks® coffee shop. Further, the marker may be identified by the client device and/or the host device based on one or more marker identification information related to the marker. The marker identification information may include without limitation, a name, a trademark, a symbol, or any other distinguishing characteristic that may be used to identify the marker. The AR object may refer to a virtual image or a virtual object, which may provide virtual information related to the marker. The virtual information may include without limitation, hours of operation, address, promotion information, phone number, customer rating, customer reviews and the like.

According to aspects of the invention, the host device 110 may be a server or other similar device. The host device 110 may be configured as an independent device, which may communicate with the client device 120 and client device 130 using a wired and/or wireless communication network, or may be configured to be included in a client device. Initially, the client device 120 may have information related to a marker image 140, which may be transmitted to the host device 110 to be shared with the client device 130.

The client device 120 may share information related to the marker image 140 with the client device 130 to provide the marker image 140, using the host device 110. More specifically, the client device 120 may transmit information related to the marker image 140 to the host 110, and the client device 130 may in turn receive information related to the marker image 140 using a communication network to display the marker image 140. Similarly, the client device 130 may share information related to the marker image 150 with the client device 120 to provide the marker image 150 to the client device 120 using the host device 110.

The information related to the marker image 140 may include information related to AR object 142 and AR object 144. The information related to the marker image 150 may include information related to AR object 152 and AR object 154. Accordingly, if the host 110 shares the received information related to the marker image 140 and the marker image 150, the client device 120 may share the marker image 140, the AR object 142 and the AR object 144, and the client device 130 may share the marker image 150, the AR object 152 and the AR object 154. As a result, the client device 120 may be provided with the information related to the marker image 140, the marker image 150, or both marker images. Similarly, the client device 130 may be provided with the information related to the marker image 140, the marker image 150, or both marker images.

Further, if the client device 130 captures a marker image on its own, before the client device 120 shares information related to the same or similar marker image with the client device 130, the shared marker image may provide the captured marker image with supplementary information or replace the captured marker image with the shared marker image as a whole. According to aspects of the invention, the client device 130 may capture a marker image A before the client device 120 shares information related to a marker image A′ with client device 130, in which the marker image A and marker image A′ may be the same or similar marker images. If the marker image A includes AR object A1 but not AR object A2, and the marker image A′ includes AR object A1 and AR object A2, the client device 120 may provide AR object A2 as supplementary information or provide the marker image A′ as a replacement marker image if the client device 120 shares information related to the marker image A′ with the client device 130.

According to aspects of the invention, the marker image 140 and the marker image 150 may be shared information. More specifically, the marker image 140 may be the shared marker image 150 that was transmitted by client device 130 through the host device. As a result, the client device 120 and client device 130 may have same or similar shaped markers as well as their related information. Accordingly, the AR object 142 may correspond to the AR object 152, and the AR object 144 may correspond to the AR object 154 but are displayed through different client devices.

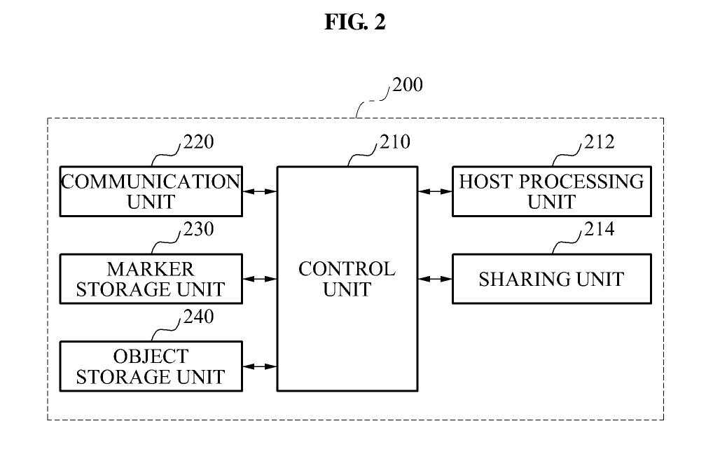

FIG. 2 is a block diagram illustrating a structure of a host device of the AR system according to an exemplary embodiment of the invention.

Referring to FIG. 2, the host device 200 includes a control unit 210, a communication unit 220, a marker storage unit 230, an object storage unit 240, a host processing unit 212, and a sharing unit 214.

The communication unit 220 may transmit and receive data to and from one or more client devices using a communication network. The communication network may include a wired network connection, a wireless network connection, and the like.

The marker storage unit 230 may store information related to a marker. The information related to the marker may include at least one of an image of the marker, marker identification information used to identify the marker, and feature information used for location tracking. According to aspects of the invention, the information related to the marker may be preset, or may be received from a client device, a host device, or a third party device using the communication unit 220.

The object storage unit 240 may store information related to an AR object. The AR object may correspond to a marker or an AR service.

According to aspects of the invention, the information related to the marker and the information related to the AR object may be preset, or may be received from a client device, the host device, or a third party device using the communication unit 220.

The sharing unit 214 may relay the information related to the marker and/or the AR object to one or more client devices that do not already have the respective information stored or displayed therein. Accordingly, relevant information, such as information related to the marker and/or the AR object, may be shared between two or more client devices participating in an AR session or member client devices. That is, the sharing unit 214 may provide the information related to the marker and the information related to the AR object to a plurality of client devices participating in an AR session so that the client devices participating in the AR session may receive or have access to the same or similar information as the client device that transmitted or provided the respective information. Also, if an AR object is added or changed in one or more of the client devices participating in the AR session, the sharing unit 214 may provide information related to the added or changed AR object to one or more client devices participating in the AR session. Accordingly, relevant information, such as information related to the marker and/or the AR object, may be synchronized between two or more client devices participating in the AR session.

The host processing unit 212 may receive a session generation request message from a client device initiating an AR session or an AR initiating client device. Further, the host processing unit 212 may also obtain relevant information from the AR initiating client device, determine whether to accept the session request, and start an AR session with the AR initiating client device. The relevant information may include, without limitation, information related to a marker or an AR object. If the host processing unit 212 receives a session generation request message from the AR initiating client device requesting generation of an AR session, the host processing unit 212 may check the information related to a marker and/or an AR object that may be included in the session generation request message. If such information is available and/or adequate, the host processing unit 212 may accept the session generation request and may start an AR session with the AR session initiating client device.

Further, the host processing unit 212 may also initiate an AR session by transmitting an AR session generation request message to a client device to establish an AR session.

In addition, if an invitation list is included in the AR session generation request message, the sharing unit 214 may transmit information about the established AR session to client devices that may be included in the invitation list or invited client devices. Accordingly, the invited client devices in the invitation list may view which client devices may have accepted to establish an AR session with the AR session initiating client device. The invitation list may include some or all of the client devices that may have received the AR session generation request message from the AR session initiating client device.

If the sharing unit 214 receives a request for information about the AR session from a client device, the sharing unit 214 may transmit the information about the AR session to the requesting client device. Also, the sharing unit 214 may transmit information about the AR session to a server accessible by the requesting client device. Accordingly, the requesting terminal may be provided with the information about the AR session through the server or directly from the host device.

According to aspects of the invention, the information related to the AR session may include, without limitation, at least one of an image of a marker, area information of the marker, a participant list, information of an AR service to be executed, a start time and an end time of the AR session, and a log record of the AR session.

If the host processing unit 212 receives a session participation request message from a client device requesting to participation in an AR session or a requesting client device, the host processing unit 212 may check participation setting information to determine whether the participation of the requesting client device is permitted. Further, the hosting processing unit 212 may transmit the result of the participation determination of the requesting client device to the requesting client device.

Determination of whether participation of the requesting client device is permitted may be based on one or more reference conditions being satisfied, a decision by the AR session initiating client device that requested generation of the AR session, or based on input of client devices currently participating in the AR session or member client devices.

The control unit 210 may control one or more operations of the host device 200. Also, the control unit 210 may control the operations of the host processing unit 212 and the sharing unit 214. Aspects of the invention separately describe the operation of the control unit 210, the host processing unit 212, and the sharing unit 214 for ease of description but the operation of individual components may be integrated in practice. Accordingly, the control unit 210 may include at least one processor configured to perform the operations of the host processing unit 212 and the sharing unit 214. Also, the control unit 210 may include at least one processor configured to perform a portion of operations of the host processing unit 212 and the sharing unit 214.

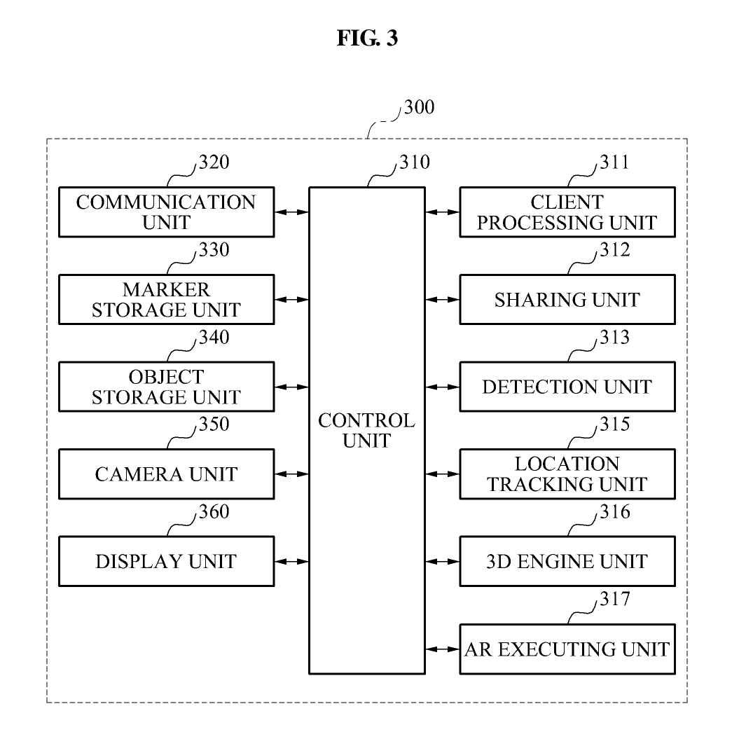

FIG. 3 is a block diagram illustrating a client device of the AR system according to an exemplary embodiment of the invention.

Referring to FIG. 3, the client device 300 includes a control unit 310, a communication unit 320, a marker storage unit 330, an object storage unit 340, a camera unit 350, a display unit 360, a client processing unit 311, a sharing unit 312, a detection unit 313, a location tracking unit 315, a 3-dimensional (3D) engine unit 316, and an AR executing unit 317.

The communication unit 320 may transmit and receive data to and from the host device or other client device using a communication network. The communication network may include a wired connection network, a wireless connection network, and the like.

The marker storage unit 330 may store information related to a marker. The information related to the marker may include at least one of an image of the marker, marker identification information used to identify the marker, and feature information used for location tracking.

The object storage unit 340 may store information related to an AR object corresponding to a marker, a sharing area, or an AR service.

According to aspects of the invention, the information related to the marker, area information related to the marker, and the information related to the AR object may be preset, or may be received from the host device, other client device, or a third party device.

The camera unit 350 may take or capture an image, and may provide the captured image to the detection unit 313 and/or the display unit 350. According to aspects of the invention, the captured image or a preview image may be subject to an image correction process or camera correction process before the image or the preview image is provided to the detection unit 313 and/or the display unit 350.

The display unit 360 may display status information or an indicator related to the client device, numbers and characters, a moving picture, and a still picture that may be captured or received. According to aspects of the invention, the display unit 360 may also display an image, that is, a marker related to the image captured through the camera unit 350 and a corresponding AR object generated by the 3D engine unit 316.

The sharing unit 312 may enable sharing of information related to a marker and/or information related to an AR object with the host device and other client devices in an AR session.

The detection unit 313 may detect a marker in a preview image or an image captured using the camera unit 350.

The location tracking unit 315 may track a location of a client device or the marker based on one or more feature information of the marker. More specifically, the feature information of a marker may be identified in the captured image, and based on that feature information the location of the marker may be identified. The feature information may include, without limitation, an address, geographic coordinate information, telephone number, and other information that may aid in identifying the location of the marker.

The 3D engine unit 316 may generate an AR object corresponding to the identified marker, which may be based at least in part on the identified location of the client device, and display the AR object using the display unit 360. The AR object may be generated in a 3D or 2D format.

The AR executing unit 317 may execute an AR service to provide the AR object information to the member client devices. Further, the AR executing unit 317 may enable sharing of information related to an AR object through the sharing unit 312. Further, if the information related to the respective AR object is changed before or during an AR session the information related to the changed AR object may be shared with the member client devices.

If the client processing unit 311 senses or detects an occurrence of an AR session generation event, the client processing unit 311 may retrieve information related to a marker, which may be stored in a host device or a client device or provided by a user input. Further, the client processing unit 311 may transmit an AR session generation request message, which may include the information related to the marker to the host device.

If the client processing unit 311 receives a session participation request message from a client device, which requests participation in an existing AR session, the client processing unit 311 may determine whether the requesting client device may participate in the AR session. The client processing unit 311 may determine whether to allow the requesting client device to participate based on a user input, input of users of other member client devices in the AR session, and/or one or more reference conditions. The result of the participation determination of the requesting client device may be transmitted to the requesting client device. The client processing unit 311 may transmit result of the participation determination of the requesting client device to the requesting client device through the host device.

If the client processing unit 311 detects an occurrence of an AR session participation event, the client processing unit 311 may obtain information related to the AR session from the host device, and may transmit a session participation request message, which may request participation in the existing AR session, to the host device.

Further, the client processing unit 311 may also receive a session invitation message from the host device. In response, the client processing unit 311 may obtain information about the AR session from the session invitation message. In addition, the client processing unit 311 may request information about the AR session to the host device or a server managing the AR session in order to obtain the information about the AR session.

According to aspects of the invention, the information of the AR session may include, without limitation, at least one of an image of a marker, a participant list, information of an AR service to be executed, a start time and an end time of the AR session, and a log record of the AR session.

The control unit 310 may control one or more operations of the client device 300. Also, the control unit 310 may control the operations of the client processing unit 311, the sharing unit 312, the detection unit 313, the location tracking unit 315, the 3D engine unit 316, and the AR executing unit 317. Aspects of the invention separately describes the operation of the control unit 310, the client processing unit 311, the sharing unit 312, the detection unit 313, the location tracking unit 315, the 3D engine unit 316, and the AR executing unit 317 for ease of description but the operation of individual components may be integrated in practice. Accordingly, the control unit 310 may include at least one processor configured to perform operations of the client processing unit 311, the sharing unit 312, the detection unit 313, the location tracking unit 315, the 3D engine unit 316, and the AR executing unit 317. Also, the control unit 310 may include at least one processor configured to perform a portion of operations of the client processing unit 311, the sharing unit 312, the detection unit 313, the location tracking unit 315, the 3D engine unit 316, and the AR executing unit 317.

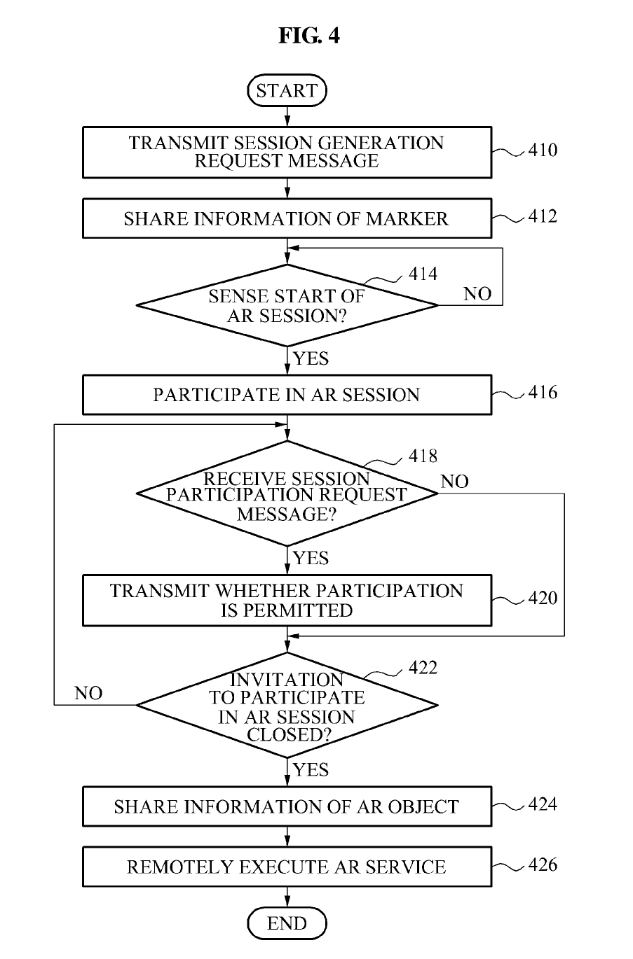

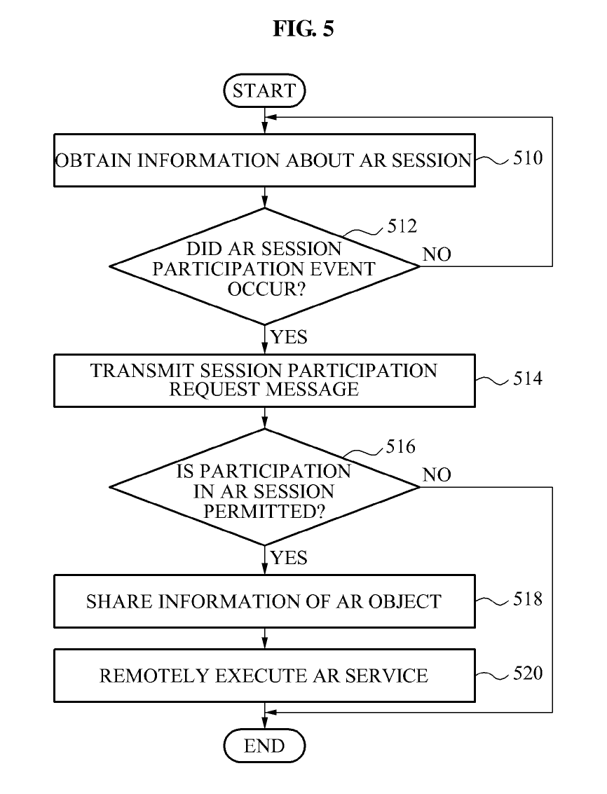

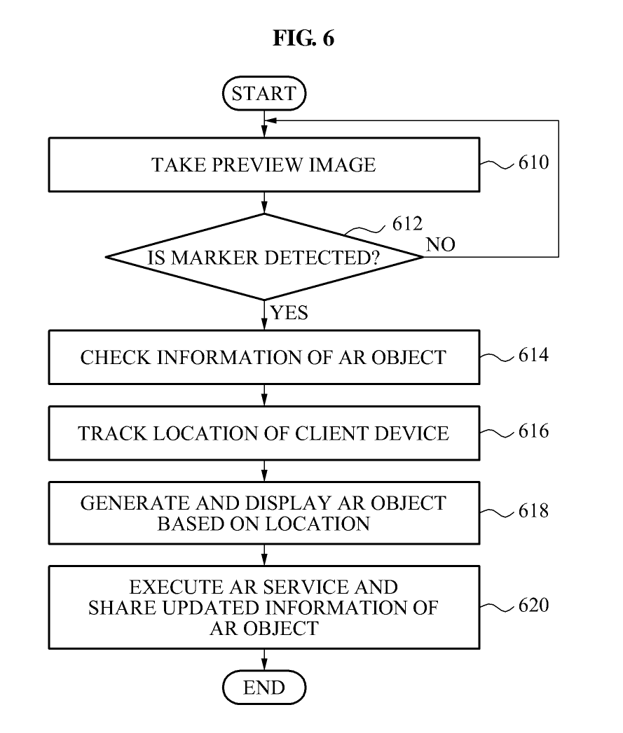

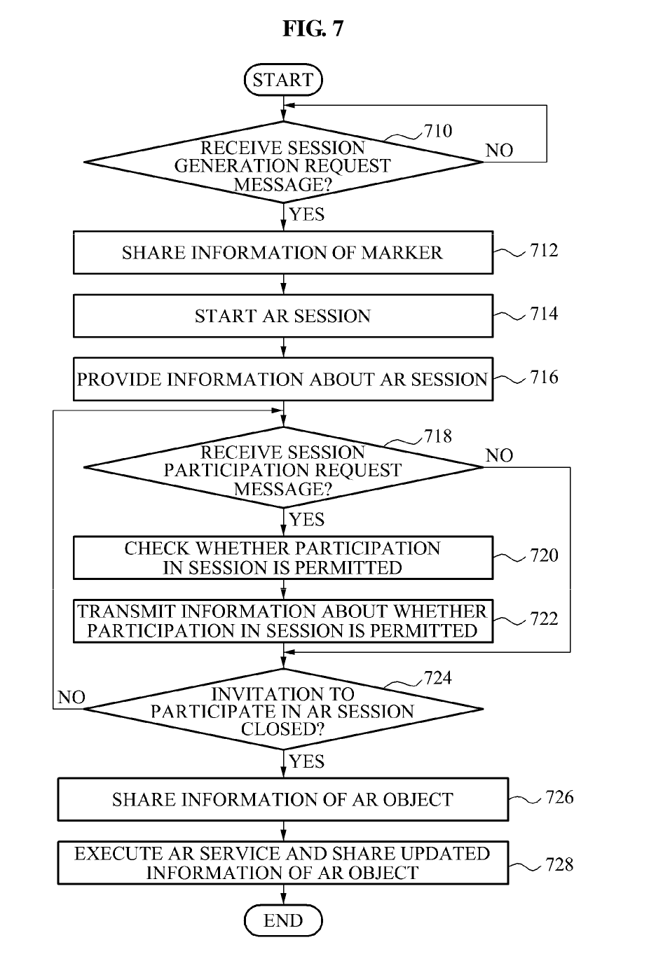

Hereinafter, a method for remotely sharing an AR service is disclosed with reference to FIG. 4, FIG. 5, FIG. 6, and FIG. 7 below. For convenience, FIG. 4, FIG. 5, FIG. 6, and FIG. 7 will be described as if the method was performed by the AR system and its components (e.g., client device and host device) described above. However, the method is not limited as such.

FIG. 4 is a flowchart illustrating a process for generating an AR session in a client device according to an exemplary embodiment of the invention.

Referring to FIG. 4, the AR session initiating client device may transmit, to the host device, a session generation request message, which may request generation of an AR session in operation 410. The session generation request may include information related to a marker. According to aspects of the invention, the session generation request message may further include an invitation list, which may include a list of client devices intended to be invited to the AR session. Further, the session generation request message may also include information related to an AR object.

In operation 412, the AR session initiating client device may share the information related to the marker with the host device. The information related to the marker may be stored in the AR session initiating client device and/or the host device. For example, if some or all information related to the marker is stored in the host device, the AR session initiating client device may seek to obtain such information from the host device by transmitting a session generation request message including an image of the marker to the host device. In response, the AR session initiating client device may receive residuary information related to the marker corresponding to the image of the marker from the host device.

If a different client device senses or detects the start or existence of the AR session by the host device in operation 414, the client device may seek to participate in the AR session in operation 416 by sending a session participation request message. The start or the existence of the AR session may be sensed or detected by receiving a session invitation message to join the AR session from the host device. The session invitation message may include, without limitation, information about the AR session, which may include at least one of information related to a marker, a participant list, information related to an AR service to be executed, a start time and an end time of the AR session, and a log record of the AR session.

If the AR session initiating client device receives the session participation request message from a requesting client device, which requests participation in the AR session, through the host device in operation 418, the AR session initiating client device may determine whether participation of the requesting client device in the AR session is permitted. The determination of whether participation of the requesting client device is permitted may be based on a user input, input of users of other member client devices in the AR session, and/or one or more reference conditions. The result of the participation determination of the requesting client device may be transmitted to the requesting client device through the host device, in operation 420.

If the AR session initiating client device does not receive a session participation request message from another client device or a requesting client device, the AR session initiating client device may skip operation 420 and proceed to operation 422.

In operation 422, the AR session initiating client device may determine whether the client device's invitation to participate in the AR session remains open or closed. If the invitation to participate in the AR session remains open in operation 422, the AR session initiating client device may return to operation 418. The participation in the AR session may be determined to be completed if one or more reference conditions are satisfied, if a user makes a request to close out outstanding invitations to the AR session, or if all of the client devices in the invitation list that were invited participate in the AR session have responded to the invitation. The invited client devices may respond to participate in the AR session or deny the invitation to participate. According to aspects of the invention, the reference condition for determining whether the invitation to participate in the AR session remains open may include, without limitation, the lapse or expiration of an invitation, obtaining minimum number of participants, obtaining maximum number of participants, and lapse of reference time or duration of the AR session.

If the invitation to participate in the AR session is closed out or no longer open in operation 422, the client device may share information related to an AR object with some or all member client devices participating in the AR session in operation 424. The information related to the AR object may be shared with some or all member client devices participating in the AR session through the host device.

In operation 426, the AR session initiating client device may remotely execute an AR service while sharing the AR service with other member client devices. Accordingly, if the information related to the AR object is determined to have changed according to the AR service, the AR session initiating client device (or other member client device) may share the changed information with the member client devices participating in the AR session.

FIG. 5 is a flowchart illustrating a process for participating in an AR session in the client device according to an exemplary embodiment of the invention.

Referring to FIG. 5, a client device may obtain information about an existing AR session in operation 510. The client device may obtain information about the AR session by receiving a session invitation message from the host device. The session invitation message may include information about the AR session. Also, the client device may request information about the AR session from the host device or a server managing the AR session to obtain the information about the AR session.

If the client device senses or detects occurrence of an AR session participation event in operation 512, the client device may transmit a session participation request message, which may request participation in the AR session, to the host device in operation 514.

In operation 516, the requesting client device may determine whether participation in the AR session is permitted. Whether participation in the AR session is permitted may be determined based on one or more reference conditions being satisfied, decision by the AR session initiating client device that requested generation of the AR session, or opinions of member client devices currently participating in the AR session.

If the requesting client device obtains permission to participate in the AR session in operation 516, the requesting client device may share information related to an AR object with some or all member client devices participating in the AR session in operation 518. The information related to the AR object may be shared with some or all member client devices participating in the AR session through the host device.

In operation 520, the requesting client device may remotely execute an AR service while sharing the AR service with other member client devices. Accordingly, if the information related to the AR object is determined to have changed according to the AR service, the AR requesting client device (or other member client device) may share the changed information with the member client devices participating in the AR session.

FIG. 6 is a flowchart illustrating a process for remotely executing an AR service in the client device according to an exemplary embodiment of the invention.

Referring to FIG. 6, a client device may take or capture a preview image or an image in operation 610.

In operation 612, the client device may detect a marker in the obtained preview image. If the marker is not detected in the preview image in operation 612, the client device may return to operation 610.

If the marker is detected in the preview image in operation 612, the client device may check for information related to an AR object corresponding to the marker in operation 614.

In operation 616, the client device may track or identify its location or the location of the marker using a feature of the marker.

In operation 618, the client device may generate an AR object based on the tracked location and may display the generated AR object on a display screen.

In operation 620, the client device may execute or provide an AR service to provide additional or changed information related to the AR object. Further, the client device may share the additional or changed information related to the AR object with other member client devices participating in an AR session. Accordingly, the member client devices having the same AR object may have the same or similar updated information related to the AR object.

FIG. 7 is a flowchart illustrating a process for remotely providing an AR service in the host device according to an exemplary embodiment of the invention.

Referring to FIG. 7, if the host device receives a session generation request message from a client device requesting generation of an AR session or an AR session initiating client device in operation 710, the host device may share information related to a marker with the AR session initiating client device in operation 712.

In operation 714, the host device may start the AR session.

In operation 716, the host device may provide information about the AR session to other member client devices that may participate in the AR session.

To provide information about the AR session, if an invitation list is included in the session generation request message, the host device may transmit information about the AR session to client devices identified in the invitation list.

In addition, if the host device receives a request for information about the AR session from a client device, the host device may transmit the information about the AR session to the requesting client device that transmitted the request. Also, the host device may transmit information about the AR session to a server accessible by the requesting client device, which may be provided with the information about the AR session through the server.

According to aspects of the invention, the information about the AR session may include, without limitation, at least one of an image of a marker, a participant list, information of an AR service to be executed, a start time and an end time of the AR session, and a log record of the AR session.

If the host device receives a session participation request message from the requesting client device requesting participation in the AR session in operation 718, the host device may determine whether participation of the requesting client device is permitted in operation 720.

The determination of whether participation of the requesting client device is permitted may be based on one or more reference conditions, a decision by the AR session initiating client device that requested generation of the AR session, or opinions of member client devices currently participating in the AR session.

In operation 722, the host device may transmit information about whether participation in the AR session is permitted to the requesting client device, which transmitted the session participation request message.

In operation 724, the host device may determine whether the client device's invitation to participate in the AR session remains open or closed. If the invitation to participate in the AR session remains open in operation 724, the host device may return to operation 718. The participation in the AR session may be determined to be completed if one or more reference conditions are satisfied, if the AR session initiating client device that requested generation of the AR session controls the invitation to participate in the AR session to close, or if all of the client devices in the invitation list that were invited participate in the AR session have responded to the invitation. The invited client devices may respond to participate in the AR session or deny the invitation to participate. According to aspects of the invention, the reference condition for determining whether the invitation to participate in the AR session remains open include, without limitation, the lapse or expiration of an invitation, obtaining minimum number of participants, obtaining maximum number of participants, lapse of reference time or duration of the AR session.

If the invention to participate in the AR session is closed out or no longer open in operation 724, the host device may relay information related to an AR object to be shared between some or all member client devices participating in the AR session in operation 726.

In operation 728, the host device may obtain and relay any changes or additions to the information related to the AR object by executing an AR service. If the information related to the AR object is changed before or during the AR service with member client devices, the changed information related to the AR object may be shared between the member client devices participating in an AR session. More specifically, the changed information related to the AR object may be obtained by a member client device, which may transmit the changed information to the host device. The host device may transmit the changed information to the other member client devices in response.

Exemplary embodiments of the present invention may provide an AR system and method for sharing information related to a marker and/or information related to an AR object between multiple client devices, which may be located at a reference distance from one another, through a host device. Accordingly, the client devices participating in an AR session may share an AR service although the client devices may be located at a distance.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard discs, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A first client device of an augmented reality (AR) system, the first client device comprising:
a communication unit to transmit and receive data to and from a host device;
a sharing unit to share information related to a marker and information related to an AR object with a second client device through the host device;
a detection unit to detect the marker in an image;
an engine unit to generate an AR object corresponding to the marker, and to display the generated AR object; and
an AR executing unit to provide an AR service to provide information related to the AR object.

2. The first client device of claim 1, further comprising:
a location tracking unit to identify a location of the marker using a feature of the marker comprised in the information related to the marker,
wherein the engine unit generates an AR object corresponding to the marker based on the identified location of the marker and displays the AR object.

3. The first client device of claim 1, further comprising:
a client processing unit to retrieve the information related to the marker, wherein the information related to the marker is stored or received from the first client device, and
to transmit a session generation request message to the host device, wherein the session generation request message requests generation of an AR session and comprises the information related to the marker.

4. The first client device of claim 3, wherein the client processing unit transmits a determination of whether participation is permitted to the second client device if the client processing unit receives a session participation request message from the second client device, wherein the session participation request message requests participation in the AR session.

5. The first client device of claim 1, further comprising:
a client processing unit to obtain information about an AR session from the host device, and to transmit a session participation request message to the host device.

6. The first client device of claim 5, wherein the client processing unit receives a session invitation message from the host device, and obtains information about the AR session from the session invitation message.

7. The first client device of claim 5, wherein the client processing unit requests information about the AR session to the host device or a server managing the AR session, and obtains the information about the AR session in response to the request.

8. The first client device of claim 5, wherein the information about the AR session comprises at least one of the information of the marker, a participant list, information of an AR service to be executed, a start time and an end time of the AR session, and a log record of the AR session.

9. A host device of an augmented reality (AR) system, the host device comprising:
a communication unit to transmit and receive data to and from client devices; and
a sharing unit to enable sharing of information related to a marker and information related to an AR object between client devices participating in an AR session through the communication unit.

10. The host device of claim 9, wherein the sharing unit transmits information related to a changed AR object to a first client device participating in the AR session, if the sharing unit receives a request to change the AR object from a second client device participating in the AR session.

11. The host device of claim 9, further comprising:
a host processing unit to check the information related to the marker comprised in a session generation request message, wherein the session generation request message requests generation of the AR session, and to start the AR session if the host processing unit receives the session generation request message.

12. The host device of claim 11, wherein the sharing unit transmits information about the AR session to an invited client device, if the invited client device is identified in the invitation list, wherein the invitation list is comprised in the session generation request message.

13. The host device of claim 11, wherein the sharing unit transmits information about the AR session to a requesting client device, if the sharing unit receives a request for the information about the AR session from the requesting client device.

14. The host device of claim 9, wherein the host processing unit checks to determine whether participation of a requesting client device is permitted and transmits the result of that determination to the requesting client device, if the host processing unit receives a session participation request message requesting participation in the AR session from the requesting client device.

15. The host device of claim 11, wherein the information about the AR session comprises at least one of the information of the marker, a participant list, information of an AR service to be executed, a start time and an end time of the AR session, and a log record of the AR session.

16. A method for remotely sharing an augmented reality (AR) service in a first client device, the method comprising:
obtaining an image of a real world environment;
detecting a marker in the image;
detecting location of the marker using a feature of the marker;
generating an AR object corresponding to the marker based on the detected location of the marker;
displaying the generated AR object;
sharing information related to a marker and information related to an AR object with a second client device in an AR session through a host device; and
executing an AR service to provide additional or changed information related to the AR object, and sharing the additional or changed information related to the AR object with the second client device.

17. The method of claim 16, wherein the sharing of the information related to the marker and the information related to the AR object comprises:
identifying the marker; and
transmitting a session generation request message requesting generation of the AR session, wherein the session generation request message comprises the information related to the marker and the information related to the AR object to a host device.

18. The method of claim 16, wherein the sharing of the information of the marker and the information of the AR object comprises:
obtaining information about the AR session from the host device; and
transmitting a session participation request message requesting participation in the AR session to the host device.

19. The method of claim 18, wherein the obtaining of the information about the AR session from the host device comprises:
receiving a session invitation message from the host device; and
obtaining the information about the AR session from the session invitation message.

20. The method of claim 18, wherein the obtaining of the information about the AR session from the host device comprises:
requesting the information about the AR session to the host device or a server managing the AR session; and
obtaining the information about the AR session in response to the request.

21. A method for remotely sharing an augmented reality (AR) service in a host device, the method comprising:
receiving a session generation request message requesting generation of an AR session from a first client device;
generating the AR session with the first client device;
receiving a session participation request message requesting participation in the AR session from a second client device;
determining whether participation of the second client device is permitted;
transmitting information about whether participation of the second client device is permitted to the second client device; and
enabling sharing of the information related to a marker and information related to an AR object between the client devices participating in the AR session.

22. The method of claim 21, further comprising:
checking for information related to the marker comprised in the session generation request message; and
transmitting additional or changed information related to the AR object to the client devices participating in the AR session if one of the client devices participating in the AR session receives a request for addition or change of information related to the AR object.
